(19) United States
(12) Patent Application Publication
(10) Pub. No.: US 2017/0136617 A1
(43) Pub. Date: May 18, 2017

(54) CUSTOMIZABLE TOOL HANDLE

(71) Applicant: KAI U.S.A., Ltd., dba Kershaw Knives, Tualatin, OR (US)

(72) Inventor: Tommie Richard Lucas, JR., Beaverton, OR (US)

(21) Appl. No.: 14/941,000

(22) Filed: Nov. 13, 2015

(51) Int. Cl. B25G 1/06; B25G 1/10; B25G 3/10; B26B 3/00

(52) U.S. Cl. CPC B25G 1/06; B26B 3/00; B25G 1/102; B25G 3/10

(57) ABSTRACT

An adjustable handle of a knife or other implement is provided. The adjustable handle allows a user or multiple users to adjust the shape of the handle to more closely match the shape of their hand while gripping the handle, to shape the handle to reduce strain on their hand, or to otherwise change the shape of the handle for other purposes. The adjustable handle includes a first end and a second end opposite the first end, and an outer gripping surface between the first end and the second end. The handle also includes a plurality of handle members positioned between the first end and the second end which are selectably moveable with respect to each other to adjust a shape of the outer gripping surface.

### BACKGROUND

Technical Field

The present disclosure generally relates to tool and methods of using tool, and more particularly to an adjustable handle for a knife or other implement and methods of using an adjustable handle.

Description of the Related Art

Knives come in a variety of shapes and sizes. Some knives have blades designed for cutting meat, other knives have blades for cutting vegetables, and still other knives have blades for cutting bread. Still other knives may have a blade for cutting bone, skinning, or for other uses. Each knife also has a handle. Knife handles may be shaped and sized based on the type of blade to which it is attached. For example, a knife for cutting bone may have a large, heavy, and sturdy handle, while a knife for cutting vegetables may have a smaller and lighter handle.

Some knife handles have ergonomic shapes that are comfortable to grip and use for long periods of time without causing excess fatigue to the user's hands. For example, some knives may have shapes that are comfortable for large hands, while other knives may have shapes that are comfortable for small hands. Some knife handles may even be designed for use by right or left-handed people. One example of such a grip is the D-shaped, nonsymmetric, cross-section of a grip designed for use with left- or right-handed users.

The shapes of conventional knife handles are fixed at the time of the knife's manufacture. Therefore, a handle shape for a large, right-handed person at the time of manufacture will always be a handle shape for a large right-handed person. In a kitchen environment, either in a professional kitchen or a home kitchen, different users will use the same knife from hour to hour or day to day. The different users will have different sized hands, and some of them may be right-handed and others left-handed; yet, in the example above, they will all use the same knife having a handle shape for a large, right-handed person unless the kitchen has multiple knives used for the same purpose, but with different sized and shaped handles, which can be very expensive.

### BRIEF SUMMARY

According to one embodiment disclosed herein, an adjustable handle is provided. The adjustable handle allows a user or multiple users to adjust the shape of the handle to more closely match the shape of their hand while gripping the handle, or to customize the shape of the handle to reduce strain on their hand or for other purposes. The adjustable handle includes a first end and a second end opposite the first end, and an outer gripping surface between the first end and the second end. The handle also includes a plurality of handle members positioned between the first end and the second end and selectably moveable with respect to each other to adjust a shape of the outer gripping surface. The handle also includes a bolster or base at the first end and a butt at the second end. A rod may be disposed along a length of the handle.

By using a handle having a plurality of handle members positioned between the first end and the second end of the handle that are selectively movable with respect to each other to adjust the shape of the outer gripping surface, a user can unlock the handle members, reconfigure the handle into a desired shape by moving the handle members relative to each other and then configure the handle such that the handle members remain fixed in the desired position (e.g., the handle members may be locked in the desired position). This allows a first user to comfortably use the knife and then when a second user desires to use the knife, the second user may similarly selectively move the handle members into a newly desired position, and then configure the handle such that the handle members remain fixed in the newly desired position. It also enables any individual user to customize the handle to his or her hand, or otherwise shape the handle as desired, such as, for example, for aesthetic purposes.

One method of reconfiguring an exterior shape of a knife handle includes providing a knife having a handle, the handle including a blade end, a butt end opposite the blade end and a reconfigurable handle portion between the blade end and the butt end, the reconfigurable handle portion including a plurality of handle members selectably moveable with respect to each other to adjust an exterior shape of the handle. The method also includes configuring the adjustable portion of the handle in an adjustable or unlocked configuration and moving one or more of the plurality of handle members to adjust the exterior shape of the handle, and then configuring the adjustable portion of the handle in a fixed or locked configuration.

### BRIEF DESCRIPTION OF THE SEVERAL VIEWS OF THE DRAWINGS

FIG. 1 is an isometric view of a knife having an adjustable handle according to one embodiment of the present disclosure.

FIG. 2 is a cross-sectional view of the knife having the adjustable handle of FIG. 1.

FIG. 3 is an isometric view of the knife having the adjustable handle of FIG. 1, with the handle thereof shown in a different shaped configuration.

FIG. 4 is a cross-sectional view of the knife having the adjustable handle in the different shaped configuration shown in FIG. 3.

FIG. 5A is an isometric view of one handle member of the adjustable handle of the knife of FIG. 1.

FIG. 5B is an end-on view of the handle member of FIG. 5A.

FIG. 6A is a side view of a handle member according to another embodiment of the present disclosure.

FIG. 6B is an opposing side view of the handle member of FIG. 6A.

FIG. 6C is an end-on view of the handle member of FIG. 6A.

FIG. 7 is cross-sectional view of the adjustable handle of the knife FIG. 1, with the handle thereof shown in another different shaped configuration.

FIG. 8 is a cross-sectional view of an adjustable handle according to another embodiment of the present disclosure.

FIG. 9 is a cross-sectional view of two handle members according to another embodiment of the present disclosure.

FIG. 10 is a perspective view of a tool having an adjustable handle according to one embodiment of the present disclosure.

### DETAILED DESCRIPTION

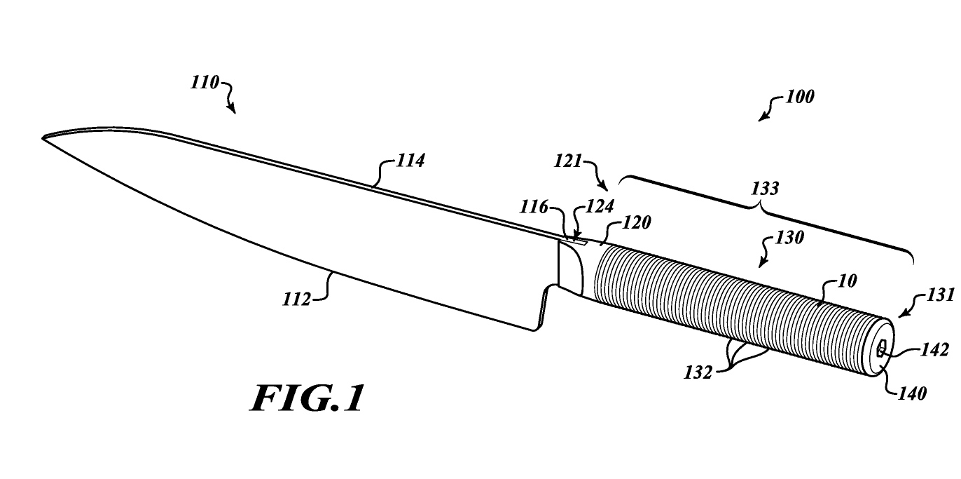

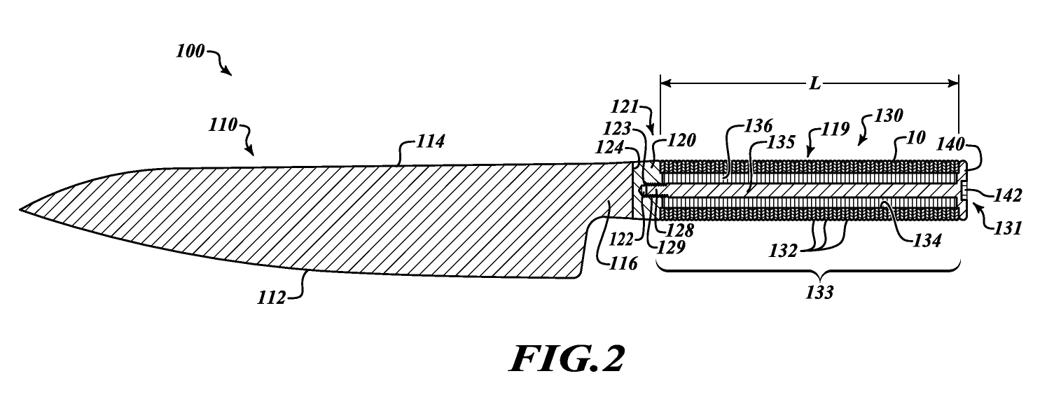

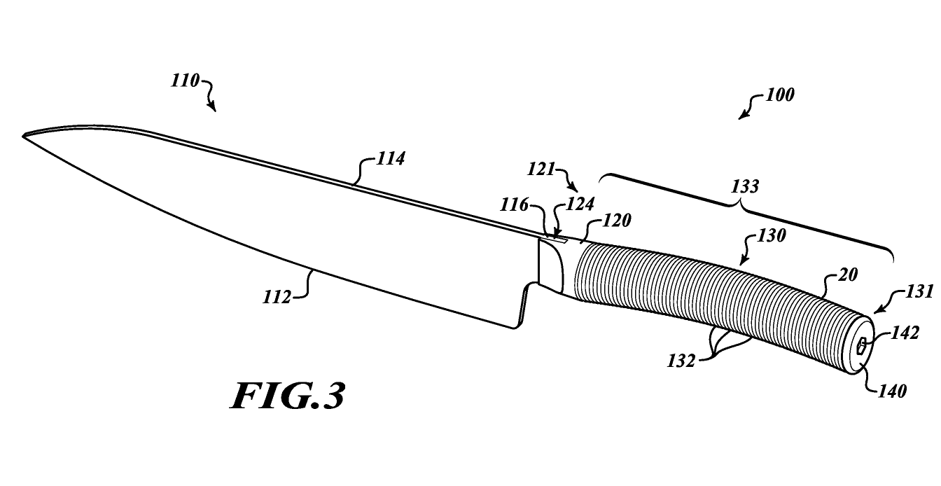

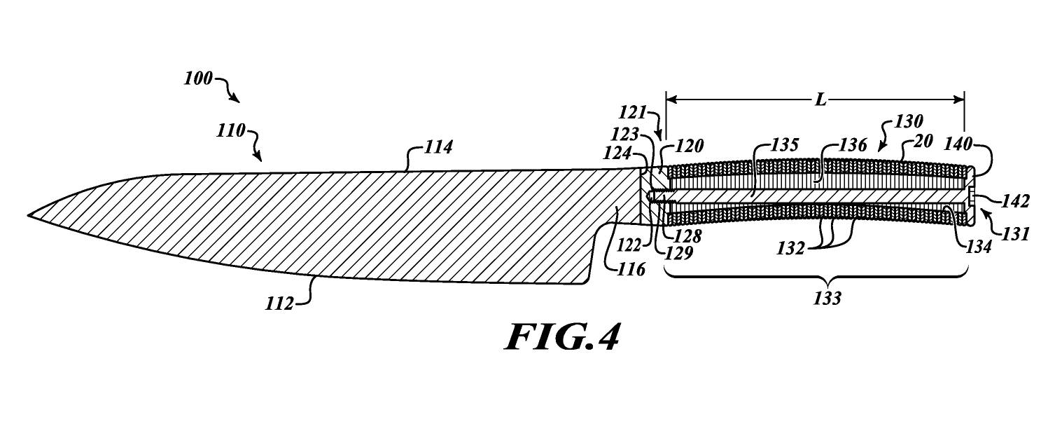

FIGS. 1 and 2 show an isometric view of a knife 100 that has an adjustable handle 130 attached to a blade 110 and a cross-sectional view of the same knife 100, respectively, with the adjustable handle 130 in one shaped configuration 10 (e.g., a straight-handled configuration). FIGS. 3 and 4 show an isometric view of the knife 100 with the adjustable handle 130 and a cross-sectional view of the same knife 100, respectively, with the adjustable handle 130 in a different shaped configuration 20 (e.g., a curved-handled configuration). With reference to FIGS. 1 through 4, the blade 110 of the knife 100 includes an edge 112 for cutting and a spine 114 that provides stiffness and support to the edge 112. The base of the blade 110 includes a tang 116.

With continued reference to FIGS. 1 through 4, the adjustable handle 130 includes an adjustable gripping region 133, comprising a plurality of handle members 132 that longitudinally spans a distance L between a butt end 131 and a blade end 121 of the handle 130. The butt end 131 of the handle 130 includes a head 140 integrally formed with a rod 135. The rod 135 spans the longitudinal length of the handle 130 between the head 140 at the butt end 131 of the handle and a base or bolster 120 at the blade end 121. The rod 135 passes through apertures 136 provided in the handle members 132. The outer surfaces of the handle members 132 collectively form the exterior shape of the handle 130.

A blade end 128 of the rod 135 is inserted into a cavity 122 of the bolster 120 at the blade end 121 of the handle 130. More particularly, the blade end 128 of the rod 135 is threaded into the cavity 122 of the bolster 120 via threads 123, 129. The threads 128 of the rod 135 and the threads 123 of the cavity 122 correspond with each other such that the blade end 128 of the rod 135 may be screwed into the cavity 122 of the bolster 120 by rotating the head 140 in a first direction, and may be unscrewed from the cavity 122 of the bolster 120 by rotating the head 140 in a second direction, opposite the first direction.

By screwing or unscrewing the rod 135 from the bolster 120, the adjustable handle may be changed from a rigid or locked configuration, wherein handle members 132 are urged against each other such that they are fixed relative to each other and resist movement relative to each other, and a reconfigurable or unlocked configuration, wherein the handle members 132 are moveable relative to each other to redefine the exterior shape of the handle 130.

In some instances, the rod 135 may be completely removed from the cavity 122 of the bolster 120. In such embodiments, handle members 132 may be removed or added to the handle 130. In addition, a longer or shorter rod may be provided to change the length or other characteristics of the handle 130. In some instances, the rod 135 may only be partially unscrewed from the cavity 122 of the bolster 120 such that the handle members 132 remain retained between the butt end 131 and the blade end 121 of the handle 130 in the reconfigurable or unlocked configuration.

The head 140 includes a socket 142 that is sized and shaped to receive a tool, such as a hex wrench or a screwdriver, which may aid in rotating the head 140 attached to the rod 135, to screw or unscrew the rod 135 from the bolster 120. As shown in the example embodiment of the knife 100 of FIGS. 1 through 4, the head 140 of the handle 130 is integral with the butt end of the rod 135 to form a locking bolt structure.

The adjustable handle 130, shown in FIGS. 1 through 4, attaches to the blade 110 via the tang 116 of the blade 110 which is received in a slot 124 within the bolster 120 of the handle 130. In some embodiments, a pin may couple the tang 116 of the blade 110 to the bolster 120. In some embodiments, the tang 116 of the blade 110 may be welded to the bolster 120, for example, the tang 116 may be inserted into the slot 124 and then welded in place. Other conventional joining techniques may be used to join the blade 110 to the handle 130. In addition, the bolster 120 may be formed integrally with the blade 110.

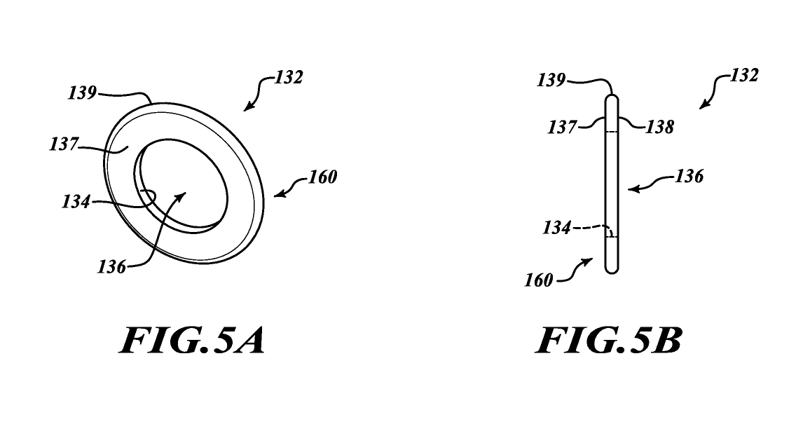

The adjustable gripping region 133 of the handle 130 includes the handle members 132, which are shown in more detail in FIGS. 5A and 5B. Referring now to FIGS. 5A and 5B, each of the handle members 132 may be annularly shaped and may include a body 160 formed between two opposing sides 137, 138. The first opposing side 137 of one handle member 132 may abut a second opposing side 138 of an adjacent handle member 132 when the handle 130 is assembled.

As shown in FIGS. 1 through 4, each handle member 132 abuts at least one adjacent handle member 132 along an entirety of the longitudinal length L of the adjustable gripping region 133. As shown in FIGS. 3 and 4, each of the handle members 132 may be shifted perpendicularly to the length L of the adjustable gripping region 133 with respect to each adjacent handle member 132 to form a shaped configuration 20 (e.g., a curved-handled configuration). In some instances, the handle members 132 may be adjusted such that the inner surface 134 defining the aperture 136 of one or more of the handle members 132 may abut the outer surface of the rod 135, such as, for example the centermost handle members 132 shown in FIG. 4.

With reference again to FIGS. 5A and 5B, each handle member 132 also includes an aperture 136 formed through the body 160 of the handle member 132 and connecting the first opposing side 138 with the second opposing side 138. The inner surface 134, which defines the aperture 136, may include a first diameter or inner perimeter. An exterior or outer surface 139 of each handle member 132 may include a second diameter or outer perimeter. The outer surfaces 139 of each of the handle members 132 of the adjustable gripping region 133 of the handle 130 form an exterior shape of a gripping surface 119 of the handle 130 and the size of the aperture 136 and the size of the outer diameter of the rod 135 determine the maximum displacement of a handle member 132 with respect to the rod 135.

Although the outer surface 139 and inner surface 134 of the handle member 132 are depicted as round in FIGS. 5A and 5B, in some embodiments the handle members 132 may have other shapes. For example, the handle members 132 may have a D-shape to more easily or more comfortably accommodate left-handed or right-handed users.

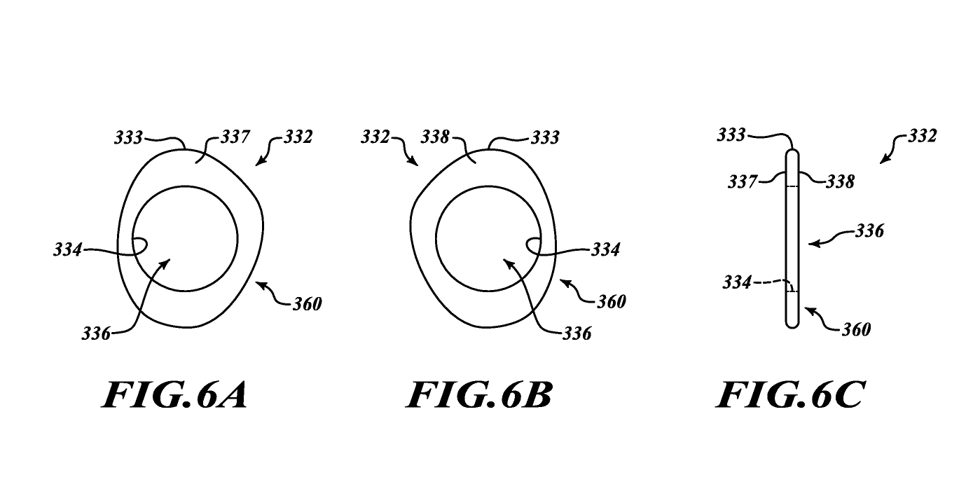

FIGS. 6A, 6B, and 6C show side views of a handle member 332 according to another embodiment in which an outer surface 333 of the handle member 332 defines a general D-shape. The handle member 332 shown in FIG. 6A is oriented for a right-handed user if viewing from the butt end of a knife handle and shows one opposing side 337, while FIG. 6B shows the handle member 332 flipped around to show opposing side 338 and oriented for a left-handed user if viewing from the butt end of a knife handle. To change a handle from a right-handed configuration to a left-handed configuration a user can remove the handle members 332, for example, by removing them from a rod of the handle, flip the handle members 332 around and put them back on the rod. In other embodiments, handle members 332 may be changed from a right-handed configuration to a left handed configuration without removing them from a handle or rod thereof, for example, by rotation the handle members 332 around the rod. In some embodiments, rotating the handle members 180 degrees can change the configuration of the handle from right handed to left handed.

Similar to the handle member 132 shown in FIGS. 5A and 5B, the handle member 332 of FIGS. 6A-6C includes a body 360 formed between two opposing sides 337, 338. The handle member 332 also includes an aperture 336 formed through the body 360 of the handle member 332 and connecting the first opposing side 337 with the second opposing side 338. An inner surface 334 of the handle member 332 defines the aperture 336. The inner surface 334 may include a first diameter or inner perimeter. An outer surface 333 of the handle member 332 may include a second diameter or outer perimeter. Outer surfaces 333 of each of a plurality of the same handle members 332 may form the gripping region of a handle, such as handle 130, and define a gripping surface of the handle. In other instances, a plurality of different sized and/or shaped handle members 132, 332 may combine to form a gripping region of an adjustable handle. The shape of the handle member 332 at the outer surface might be an oval, an ellipse, a cam shape or other complex shape, as shown. In addition, the inner diameter can be an oval, an ellipse, an inner cam shape, or the like. The member 332 does not need to have a uniform radius for the aperture, the body of the material or the outer surface 333, as can be seen in the figures.

Referring back to FIGS. 1 through 4, the handle 130 is shown in a rigid configuration, wherein the butt end 131 of the handle 130, in particular the head 140, and the blade end 121 of the handle 130, in particular the bolster 120, urge the individual handle members 132 together. In such a configuration, the rod 135 is in tension and urges the head 140 and bolster 120 together, thereby clamping the handle members 132 together. The friction between opposing faces 137, 138 of the handle members 132 in combination with the clamping force imparted by the head 140, the bolster 120, and the rod 135 aid in preventing the handle members 132 from moving relative to each other or otherwise changing position inadvertently (e.g., they are locked in position).

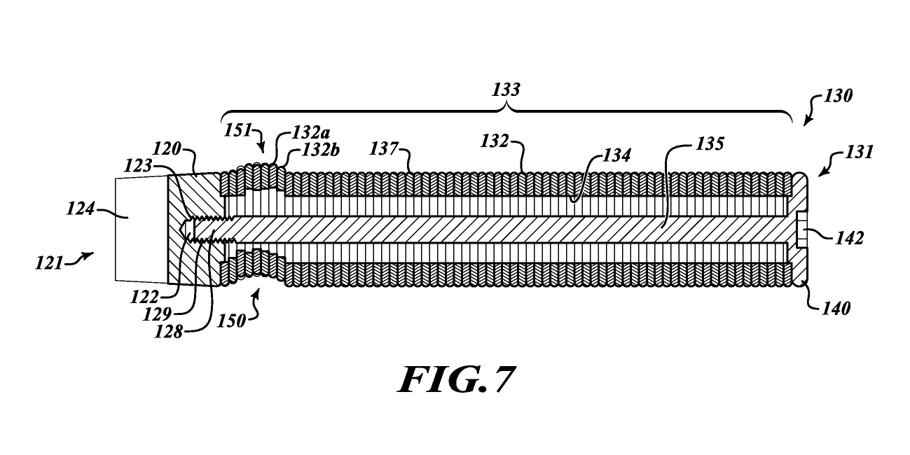

FIG. 7 shows the reconfigurable handle 130 in a different shaped configuration. FIG. 7 shows how the handle members 132 may be positioned relative to each other to change the shape of a gripping region 133. In the shape shown in FIG. 7, the majority of the handle members 132 are in a position where the outer surfaces 137 of the handle members 132 form a substantially cylindrical shape, as shown in the rightmost portion of the handle 130. Some of the handle members 132 of the leftmost portion of the handle 130 are displaced relative to the rightmost handle members 132.

To adjust the position of the handle members 132, for example handle member 132a and handle member 132b, a hex wrench or other tool may be inserted into the socket 142 of the head 140 and the head 140 and the rod 135 may be rotated to at least partially withdraw the blade end 138 of the rod 135 from the cavity 122. This reduces or removes the clamping force that holds the handle members 132a, 132b in place and allows the handle members 132a, 132b to move.

As shown in FIG. 7, the handle members 132a, 132b may be shifted relative to the other handle members 132 in a direction transverse to the longitudinal length L of the adjustable gripping region 133. Such a shift changes the shape of the gripping region 133 of the handle 130. For example, the handle 130 shown in FIG. 7 has been shaped to include a recess 150 at an edge side of the handle 130 near the bolster 120 and a protrusion 151 at the spine side of the handle 130. The recess 150 may be formed to receive the index finger of a user, while the protrusion 151 may provide a resting place or a stop for a user's thumb. The recess 150 and the protrusion 151 may also aid in preventing a user's hand from slipping towards the blade 110 of the knife 100 during use.

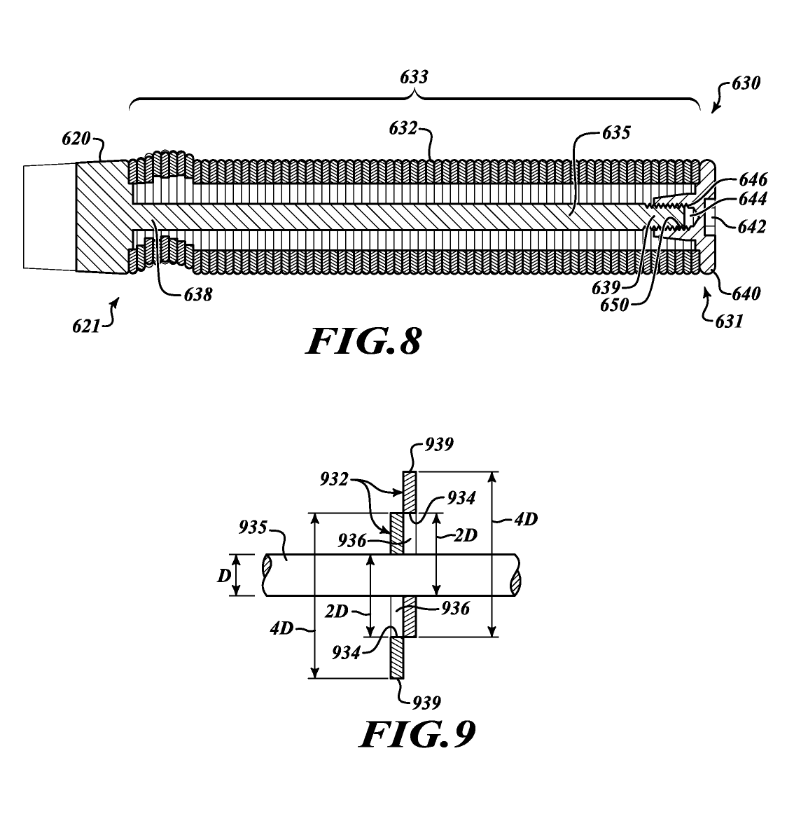

FIG. 8 shows another embodiment of an adjustable handle 630. The adjustable handle 630 includes a gripping region 633 that longitudinally spans the distance between a butt end 631 and a blade end 621 of the handle 630. A blade end 638 of the rod 635 is fixedly attached to or formed integrally with the bolster 620 at the blade end 621 of the handle 630. A butt end 639 of the rod 635 is provided with threads 650. The butt end 631 of the handle 630 includes a threaded fastener or nut, such as the threaded head 640 that is attached to the rod 635. The threads 650 of the rod 635 and the threads 646 of a cavity 644 of the threaded head 640 correspond with each other such that the butt end 639 of the rod 635 may be screwed into the cavity 644 of the threaded head 640.

Similar to the embodiment shown in FIGS. 1 through 4, by screwing or unscrewing threaded head 640 from the rod 635, the adjustable handle 630 may be changed from a rigid or locked configuration, wherein a plurality of handle members 632 thereof (similar to handle members 132 of FIGS. 1 through 5B or handle members 332 of FIGS. 6A and 6B) are urged against each other such that they resist movement relative to each other, and a reconfigurable or unlocked configuration, wherein the handle members 632 are repositionable relative to each other to change an external shape or profile of the adjustable handle 630.

The threaded head 640 includes a socket 642 configured to receive a tool, such as a hex wrench or a screwdriver, that may rotate the head 640 to screw or unscrew the threaded head 640 from the rod 635.

To adjust the handle member 632, a hex wrench or other tool may be inserted into the socket 642, and the head 640 may be rotated to at least partially withdraw head 640 from the butt end 639 of the rod 635. This reduces or removes the clamping force that holds the handle members 632 in place and thereby allows the handle members 632 to move relative to each other.

Referring now to FIG. 9, in some embodiments, a plurality of like handle members 932 may be provided with a round exterior profile and a round aperture 936 passing therethrough. In some instances, the diameter of the apertures 936 of the handle members 932 may be twice the diameter, D, of a cylindrical rod 935 upon which the handle members are 932 provided, and the outer diameter of the handle members 932 may be at least four times the diameter of the rod 935. Such a relationship between diameters prevents a gap from forming between adjacent handle members 932 at their maximum and opposite displacements, as illustrated in FIG. 9.

In some embodiments, the diameter or perimeter of the outer surface 939 may be greater than or equal to three times the perimeter or diameter of the inner surface 934. In some embodiments, the diameter or perimeter of the outer surface 939 may be greater than or equal to two times the perimeter or diameter of the inner surface 934.

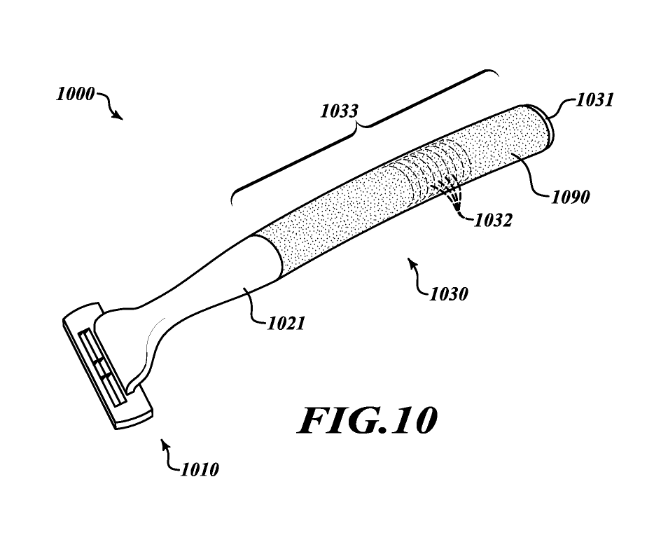

FIG. 10 shows a tool 1000 with an adjustable handle 1030. In the embodiment shown in FIG. 10, the tool 1000 is a razor, but in other embodiments, the tool 1000 may be another type of tool, for example, a peeler, knife, brush, or another type of tool. The handle 1030 includes an adjustable gripping region 1033 comprising a plurality of handle members 1032 that longitudinally spans a distance between a butt end 1031 and a tool head end 1021 of the handle 1030.

In the embodiment shown in FIG. 10, the adjustable gripping region 1033 is covered with a cover 1090. The cover 1090 surrounds the plurality of handle members 1032 that make up the adjustable gripping region 1033. In some embodiments, the cover 1090 may be made from elastic material, such as rubber, latex, polyurethane, or other material. The cover 1090 may protect the handle members 1032 from contaminants, while still allowing the handle members 1032 to move and be adjustable relative to each other.

The tool 1000 includes a head 1010, a shaving razor, attached to the head end 1021 of the handle 1030. Although depicted at fixedly attached and integral with the handle 1030, in some embodiments, the head 1010 may be detachably coupled to the head end 1021 of the handle 1030.

Although the various embodiments illustrated in the figures are directed to knives and knife handles and razors, it is appreciated that aspects of the adjustable handles provided herein may be provided in connection with a wide variety of handheld implements, including, for example, cutlery, peelers, other kitchen ware, and razors.

Moreover, aspects and features of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A knife, comprising:
a blade including a cutting edge and a spine opposite the cutting edge; and
a handle coupled to the blade, the handle including
a blade end,
a butt end opposite the blade end, and
a reconfigurable handle portion between the blade end and the butt end, the reconfigurable handle portion including a plurality of handle members selectably moveable with respect to each other to adjust an exterior shape of the handle.

2. The knife of claim 1 wherein the handle is moveable between a rigid configuration, in which the moveable handle members are fixed relative to each other, and a manipulable configuration, in which the moveable handle members are moveable relative to each other to redefine the exterior shape of the handle.

3. The knife of claim 2 wherein the handle members are urged together when in the rigid configuration.

4. The knife of claim 2 wherein the handle members are each selectably movable in a direction transverse to a longitudinal length of the handle when the handle is in the manipulable configuration.

5. The knife of claim 2 wherein when the handle is in the manipulable configuration, the handle members remain retained between the butt end and the blade end.

6. The knife of claim 1 wherein each handle member abuts an adjacent handle member along an entirety of a longitudinal length of the reconfigurable handle portion.

7. The knife of claim 1 wherein the handle is reconfigurable between a straight handle and a curved handle.

8. The knife of claim 1 wherein the handle further comprises:
a head at the butt end; and
a rod extending along at least a portion of a longitudinal length of the handle.

9. The knife of claim 8, wherein a first end of the rod is integrally coupled to the head and a second end of the rod, opposite the first end, is releasably coupled to a bolster coupled between the blade and the handle.

10. The knife of claim 8, further comprising:
a bolster, the handle fixedly coupled to the bolster via the blade end of the rod and the butt end of the rod is releasably coupled to the head.

11. The knife of claim 1 wherein each of the plurality of handle members includes two opposing faces, an outer surface, and an inner surface defining an aperture through the handle member.

12. The knife of claim 1 wherein each of the plurality of handle members has an annular shape.

13. The knife of claim 8 wherein each of the plurality of handle members includes an aperture extending completely through the handle member and an outer surface that defines a portion of the exterior shape of the handle.

14. The knife of claim 13 wherein the rod passes through the aperture of each of the handle members.

15. A handle for a tool or other implement, the handle comprising:
a first end, a second end opposite the first end, and an outer gripping surface between the first end and the second end;
a base at the first end;
a butt at the second end;
a rod disposed along a length of the handle; and
a plurality of handle members positioned along the rod between the first end and the second end and selectably moveable with respect to each other to adjust a shape of the outer gripping surface.

16. The handle of claim 15 wherein a first end of the rod is coupled to the base and a second end of the rod is coupled to the butt.

17. The handle of claim 16, wherein the first end of the rod is integrally coupled to the base and the second end of the rod is releasably coupled to the butt.

18. The handle of claim 16, wherein the butt is a threaded fastener.

19. The handle of claim 16, wherein the first end of the rod is releasably coupled to the base and the second end of the rod is fixedly coupled to the butt.

20. The handle of claim 19, wherein the butt is a fastener head.

21. The handle of claim 15 wherein each of the plurality of handle members has an annular shape.

22. The handle of claim 21, wherein each of the plurality of handle members includes two opposing faces, an outer surface, and an inner surface defining an aperture through the handle member.

24. The handle of claim 22, wherein the rod passes through the aperture of each of the handle members.

24. The handle of claim 20, wherein the handle is moveable between a first configuration, wherein the moveable members are urged together and substantially resist movement relative to each other, and a second configuration wherein the moveable members are moveable relative to each other.

25. The handle of claim 22 wherein the inner surface of the handle members has a first diameter and the outer surface of the handle members has a second diameter, the second diameter being at least three times the first diameter.

26. A method of reconfiguring an exterior shape of a handle of a tool or other implement, the method comprising:
providing an implement having a handle, the handle including a head end, a butt end opposite the head end and a reconfigurable handle portion between the head end and the butt end, the reconfigurable handle portion including a plurality of handle members selectably moveable with respect to each other to adjust an exterior shape of the handle;
configuring the reconfigurable handle portion in an adjustable configuration;
moving one or more of the plurality of handle members to adjust the exterior shape of the handle; and
configuring the reconfigurable handle portion in a fixed configuration such that the plurality of handle members are fixed relative to each other.

27. The method of claim 26 wherein configuring the adjustable handle portion in the adjustable configuration includes rotating a butt end portion of the handle in a first rotational direction.

28. The method of claim 26 wherein moving one or more of the plurality of handle members to adjust the exterior shape of the handle includes moving one or more of the plurality of handle members in a direction perpendicular to a length of the reconfigurable handle portion.

29. The method of claim 26 wherein moving one or more of the plurality of handle members to adjust the exterior shape of the handle includes changing the exterior shape of the handle from straight to curved.

30. The method of claim 26 wherein configuring the adjustable handle portion of the handle in the fixed configuration includes urging the handle members together.

31. The method of claim 27 wherein configuring the adjustable handle portion in the fixed configuration includes urging the handle members together by rotating a butt end portion of the handle in a second rotational direction opposite the first rotational direction.
